(19) United States
(12) Patent Application Publication
(10) Pub. No.: US 2026/0079295 A1
(43) Pub. Date: Mar. 19, 2026

(54) MULTILAYERED PHOTONIC DEVICES WITH TAPERED WAVEGUIDES

(71) Applicant: Xscape Photonics Inc., Fort Lee, NJ (US)

(72) Inventors: Brian West, Hamilton (CA); Samira Karimelahi, Los Gatos, CA (US); Alexander Gaeta, New York, NY (US); Vivek Raghunathan, Mountain View, CA (US); Michal Lipson, New York, NY (US); Leanne Catherine Gruner Dias, Richmond (CA)

(21) Appl. No.: 19/322,144

(22) Filed: Sep. 8, 2025

Related U.S. Application Data
(60) Provisional application No. 63/694,604, filed on Sep. 13, 2024.

(51) Int. Cl. G02B 6/122

(52) U.S. Cl. CPC G02B 6/1228

(57) ABSTRACT

A photonic integrated circuit includes: a substrate; a cladding layer; a first waveguide composed of a first material and disposed within the cladding layer, the first waveguide including a tapered section that terminates at an end of the first waveguide, the tapered section of the first waveguide including segments each having a width that varies according to a different function; and a second waveguide composed of a second material and disposed within the cladding layer, the second waveguide including a tapered section that terminates at an end of the second waveguide, the tapered section of the second waveguide including segments each having a width that varies according to a different function. The first and second materials are different, the first and seconds waveguides are offset from each other in a vertical direction, and the tapered sections of the first and seconds waveguide overlap each other.

### CROSS-REFERENCE TO RELATED APPLICATIONS

This application claims the benefit of priority to U.S. Application No. 63/694,604, filed on Sep. 13, 2024, the contents of which are hereby incorporated by reference.

### BACKGROUND

Silicon photonic devices, e.g., photonic integrated circuits (PIC), utilize silicon as an optical medium and semiconductor fabrication techniques for patterning the devices with sub-micron precision. Because silicon is used as a substrate for most integrated circuits, silicon photonic devices can be hybrid devices that integrate both optical and electronic components onto a single microchip. Silicon photonic devices can also be used to facilitate data transfer between microprocessors, a capability of increasing importance in modern networked computing.

### SUMMARY

A multilayered, silicon-photonic device, such as a photonic integrated circuit, can include a “vertical transition” between waveguides in two or more different layers of the device. In the vertical transition, an optical signal travels from one layer to another, e.g., from a lower silicon (Si) waveguide to an upper silicon nitride (SiN) waveguide. Efficient power transfer from one waveguide to another typically occurs when the effective refractive index, at the wavelength of the optical signal, is the same in each of the two waveguides, e.g., the optical signal is “phase-matched” between the two waveguides. To achieve this phase-matching condition, either one or both of waveguides that are vertically offset from each other can be tapered in width, so that at some position along the direction of tapering, the effective refractive indices of the two waveguides are equal.

The effective refractive index is partially determined by the width, e.g., as measured along a horizontal direction perpendicular to the propagation axis of the optical signal, of the waveguides. For waveguides composed of materials with significantly different refractive indices, achieving the phase-matched condition can lead to widths that are problematically small in one or both of the waveguides, e.g., particularly in the waveguide with a higher index of refraction.

For example, when the width of a waveguide is significantly smaller than the wavelength of a guided mode in the waveguide material, e.g., less than half of the wavelength, the electric field confined in the waveguide overlaps significantly with the etched sidewalls of the waveguide, which can include impurities or roughness on the nanoscale. Roughness and impurities can lead to unwanted optical absorption, which can cause catastrophic optical damage in the device. As another example, when high optical power is transmitted through a narrow waveguide, the intensity of the optical field within the waveguide may cause significant optical loss through two-photon absorption (TPA).

Multilayered, silicon-photonic devices with tapered waveguides are described. The described devices can, in certain examples, address the problems described above. In some implementations, the waveguides include tapered sections including multiple segments that vary in width non-linearly. The non-linear width variation can cause more efficient power transfer between waveguides in a multilayered device compared to waveguides including tapered sections that vary in width according to a linear function. The non-linear width variation can vary according to one or more than one different function along the length of the taper.

In some implementations, waveguides have a forked structure, which can reduce the risk of overheating because the power carried by the waveguide is split between the different tines of the forked structure as the width of the waveguide narrows.

In some implementations, the device can include two parallel vertical transitions, each carrying about one-half of the total optical power.

In some implementations, the device can include a mode converter, which changes a guided mode in the waveguide to a mode for which the waveguide has a lower effective refractive index, allowing phase matching conditions to occur for smaller width differentials between the waveguides. Beneficially, the disclosed devices can avoid problematically small widths of waveguides, which can lead to optical absorption and risk the narrowest portion of a waveguide breaking.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic of a portion of a device including overlapping waveguides with a tapered structure. FIG. 1B is a cross-section of a device, along the line A-A′, including the configuration from FIG. 1A.

FIG. 2A is a schematic of a portion of a device including overlapping waveguides with a multi-segmented, tapered structure. FIG. 2B is a cross-section of a device, along the line B-B′, including the configuration from FIG. 2A.

FIG. 3 depicts a graph of the effective refractive indices of the waveguides of FIG. 2A as a function of location for particular guided modes.

FIGS. 4A, 4B, and 4D depict schematics of examples of overlapping waveguide devices with a forked structure. FIG. 4C is a cross-section, along line C-C′, of a device including the configuration from FIG. 4A.

FIG. 5 depicts a schematic of overlapping waveguides of a device, one of the waveguides including a mode converter.

FIG. 6 depicts a system including any of the devices of FIGS. 1A, 2A, 4A, 4B, 4D, and 5.

Like reference numbers and designations in the various drawings indicate like elements.

### DETAILED DESCRIPTION

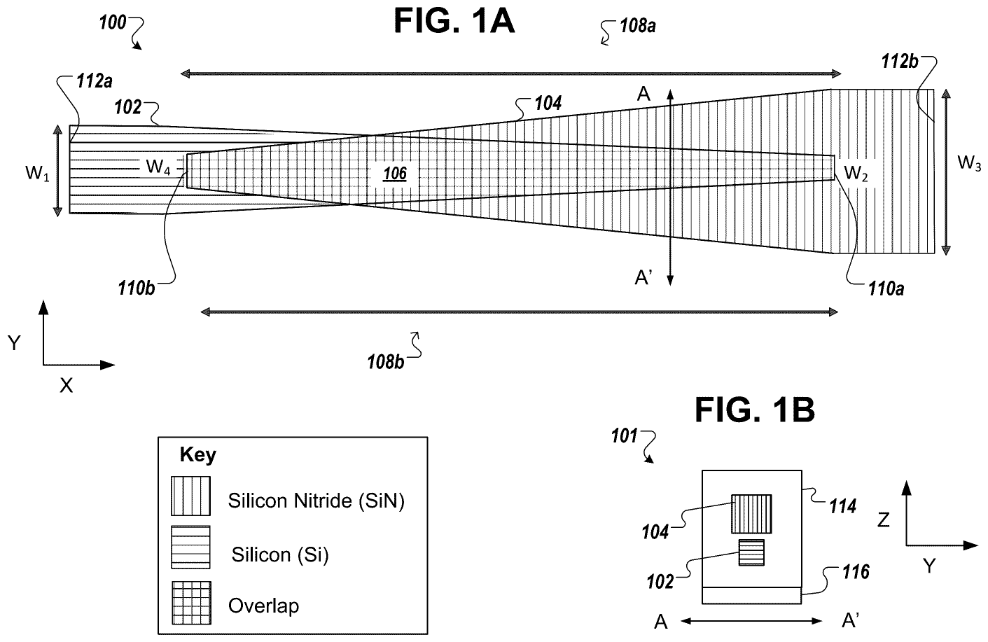

With reference to FIGS. 1A and 1B, a device 101, e.g., a photonic integrated circuit, has a multilayered structure, e.g., waveguides 102 and 104 overlapping each other along a vertical direction, e.g., the Z direction. Waveguides 102 and 104 are composed of different materials. The key indicates the material composition of an area. A first material of waveguide 102 is marked by horizontal lines, a second material of waveguide 104 is marked by vertical lines, and a pattern filled with both horizontal and vertical lines indicates an overlapping region 106. In other words, in a plan view along the Z direction, a portion of the waveguide 102 is below a portion of the waveguide 104 in overlapping region 106.

With reference to device 100, each of waveguides 102 and 104 extends in a propagation direction, e.g., either the positive or negative X direction, depending on the location of the light source. As depicted, waveguide 102 extends in the positive X direction, and waveguide 104 extends in the −X direction. For example, when an optical signal, e.g., a guided mode, propagates from left to right along the +X direction, the overlapping region 106 transfers the optical signal vertically upwards from waveguide 102 to waveguide 104. Alternatively, when the optical signal propagates from right to left in the −X direction, the overlapping region 106 transfers the optical signal vertically downwards from waveguide 104 to waveguide 102. When the material and geometric properties of the waveguides satisfy a constraint, which will be explained in depth below, the optical signal undergoes a vertical transition, e.g., along the Z direction in this example. While the following description refers to propagation in the +X direction from waveguide 102 to waveguide 104, it is valid for propagation and vertical transition in either direction, e.g., +/−Z direction.

Each of waveguides 102 and 104 includes a tapered section, e.g., tapered sections 108a and 108b, respectively. Double-sided arrows indicate the tapered sections 108a and 108b for each of the waveguides 102 and 104, respectively. In the tapered section 108a, a width of waveguide 102 narrows in the +X direction from a maximum width W₁ to a minimum width W₂. In the tapered section 108b, the width of waveguide 104 widens in the +X direction from a minimum width W₄ to a maximum width W₃. When an optical signal vertically transitions from on waveguide to another, the transfer occurs as one waveguide narrows and the other waveguide widens relative to a direction of travel of the optical signal.

In this example, each of the tapered sections 108a and 108b vary in width according to respective linear functions. Each of waveguides 102 and 104 is symmetric along an axis parallel to the X direction, and centers of the waveguides 102 and 104 along the Y direction are aligned so that the overlapping region 106 is also symmetric along an axis parallel to the X direction.

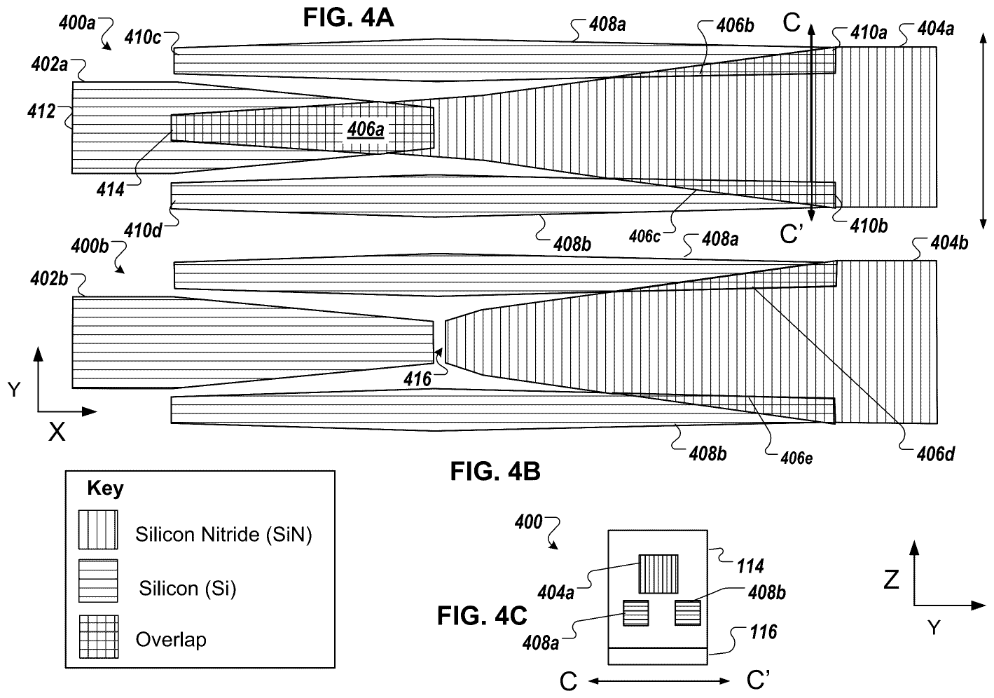

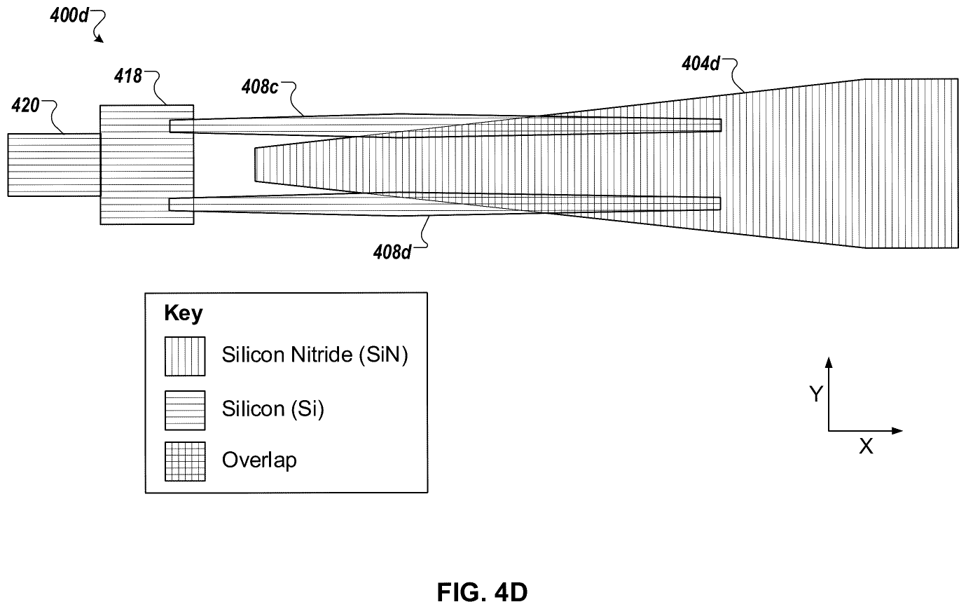

Each of the tapered sections 108a and 108b terminate at respective ends 110a and 110b of the waveguides 102 and 104. Compared to the opposite ends 112a and 112b, respectively, of the waveguide 102 and 104, the ends 110a and 110b are narrower (as measured along the Y axis). For example, waveguide 102 has the maximum width W₁ at end 112a and the minimum width W₂ at and 110a, and waveguide 104 has the maximum width W₃ at and 112b and the minimum width W₄ at end 110b. In some implementations, the thicknesses, e.g., the dimension of the waveguides along the Z direction, the width W₂ at end 110a, and the width W₄ at end 110b are constrained by processing limitations. The widths throughout the waveguides, e.g., the values between W₁ and W₂ and the values between W₃ and W₄ can be selected based on such constraints, such as a minimum thickness set by fabrication processes. As will be explained with reference to FIG. 4B, in some implementations, e.g., when waveguides vertically overlap each other, other processing limitations constrain include a minimum separation between waveguides on the same vertical level.

As revealed in the cross sectional view along line A-A′ in FIG. 1B, waveguides 102 and 104 are vertically offset from each other, e.g., waveguide 104 is disposed above waveguide 102 along the Z direction. The waveguides 102 and 104 are disposed within a cladding layer 114. The substrate 116 supports the cladding layer 114 and the waveguides 102 and 104. For example, the substrate 116 can be silicon, and the cladding layer can be silicon dioxide (SiO₂). In the cross-section of FIG. 1B, the width, e.g., as measured along the Y direction, of waveguide 104 is greater than that of waveguide 102.

The effective refractive index n_{eff} of a waveguide for a given a mode depends on the width, thickness, and material composition of the waveguide, and surrounding cladding layer. When the waveguides 102 and 104 are composed of different materials that have different refractive indices at the operative wavelength(s), e.g., silicon and silicon nitride, respectively, the effective refractive indices of the two waveguides 102 and 104 are equal at a specific location along the propagation axis, e.g., the X direction. For convenience, this position is denoted as X_{eq}. As another example, waveguide 104 can be composed of a polysilicon material with a refractive index similar to Si, and X_{eq} can occur when the waveguides 102 and 104 are nearly the same width. In general, the waveguides can be composed of silicon, polysilicon, silicon nitride, thin film lithium niobate (TFLN), photonic polymers, and/or III-V semiconductors. In this example, X_{eq} occurs at the location of the line A-A′.

To the left of X_{eq}, the effective refractive index of the silicon nitride waveguide is less than that of the silicon waveguide (n_{eff_SiN}<n_{eff_Si}), and to the right of X_{eq}, the effective refractive index of the silicon waveguide is less than that of the silicon nitride waveguide (n_{eff_Si}<n_{eff_SiN}). At typical operative wavelengths used in integrated photonics, the refractive index of silicon is greater than that of silicon nitride. As a result, to achieve the phase matching condition, the difference between the widths of the waveguides is relatively large, and the phase-matching width of the waveguide 102 is relatively narrow, e.g., less than 200 nm when phase-matching Si with SiN.

Although the phase-matching condition is met at X_{eq} because the waveguide 102 is sufficiently narrow relative to waveguide 104, waveguide 102 continues to narrow toward the end 110a. The waveguides 102 and 104 continue to taper past X_{eq} because if the widths of each of the waveguides 102 and 104 remain the same (thus maintaining the phase-matching condition), the optical signal oscillates between the two layers of the waveguides 102 and 104 rather than fully transferring upward to waveguide 104. Thus, the waveguide 102 tapering to widths smaller than the width at X_{eq} and the waveguide 104 tapering to widths greater than the width at X_{eq} increases the amount of power transfer.

At such a narrow width in the tapered section 108a of the waveguide 102, the electric field of any remaining portion of the guided mode significantly overlaps etched sidewalls of the waveguide 102. The sidewalls can include impurities and/or roughness at the nanoscale, which can lead to unwanted optical absorption. Given the small scale of the waveguide 102, e.g., tens of microns, such optical absorption can lead to a large local temperature increase, causing catastrophic optical damage.

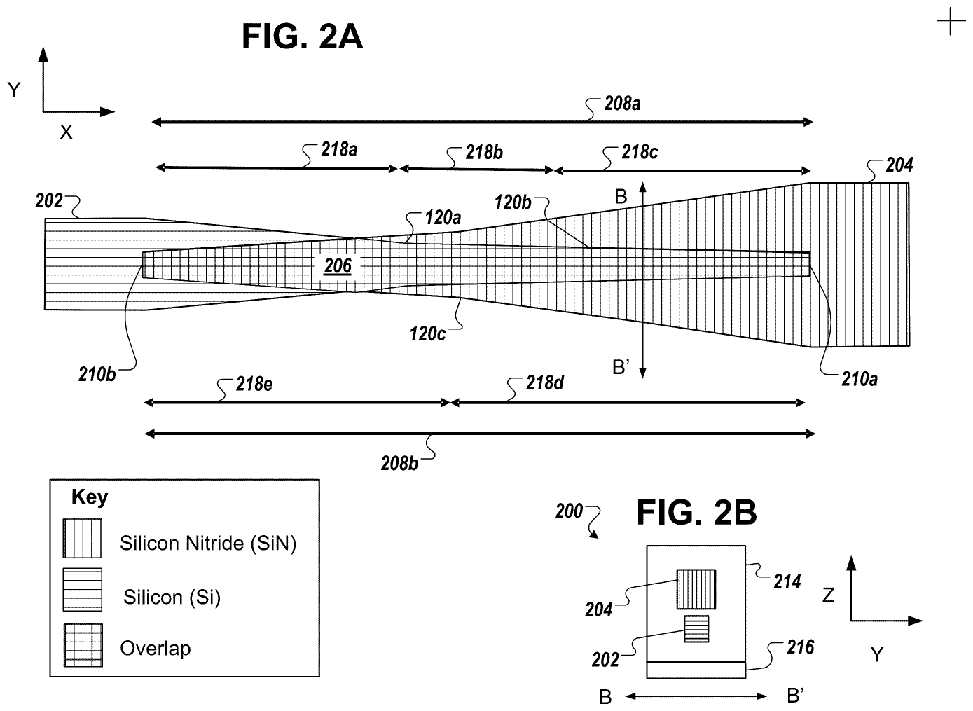

With reference to FIGS. 2A and 2B, a first example provides a device 200 that allows for a relatively wide end 210a, e.g., greater than 150 nm, while still achieving the phase matching condition. The materials properties of waveguides 202 and 204 are similar to waveguides 102 and 104 of FIGS. 1A and 1B, and repeated description will be omitted. Further, as depicted in FIG. 2B, which is a cross-sectional view along line B-B′ from FIG. 2A, waveguides 202 and 204 are disposed in a cladding layer 214 supported by a substrate 216.

The main difference between waveguides 102 and 104 versus waveguides 202 and 204 is that instead of the tapered sections 108a and 108b linearly varying in width according to a respective, single function, each of tapered sections 208a and 208b include multiple segments 218 that vary in width according to unique functions. Accordingly, the boundary of overlapping region 206 is defined by multiple functions. For example, the functions can include linear, exponential, parabolic, and general numerically optimized functions, each parameterized with different coefficients. For example, a numerically optimized function may not correspond to a general type of function, e.g., parabolic or linear, but rather be a function that minimizes a loss function. For example, the loss function can quantify how much optical power is transferred from one layer to another based on a shape of the tapered sections, and minimizing the loss function can provide a function that corresponds to maximum optical power transfer.

The tapered section 208a of waveguide 202 includes segments 218a, 218b, and 218c, each of which vary according to a unique function. For example, along the X direction, the width of segment 218a decreases linearly, the width of segment 218b decreases with positive concavity, and the width of segment 218c decreases with negative concavity. Points 120a and 120b mark where the functions determining the width of the waveguide 202 along the horizontal direction perpendicular to the propagation direction, e.g., the Y direction in this example, change. The tapered section 208b includes segments 218d and 218e, terminating at end 210b, with the point 120c marking where the function determining the width of waveguide 104 changes.

Although FIG. 2A depicts an example where the tapered section 208a has three segments and the tapered section 208b has two segments, other variations are possible. For example, each of the tapered sections 208a and 208b can have four or more segments, e.g., between 4 and 50.

By varying the width of each of the tapered sections 208a and 208b according to different functions, the difference in effective refractive indices (Δn_{eff}=n_{eff_Si}−n_{eff_SiN}) as a function of position along the propagation direction can be tuned to maximize the optical power transfer between waveguides. For example, in FIG. 2A, waveguide 202 has exponentially decreasing widths in segments 218a, 218b, and 218c that produce a more rapid narrowing of the waveguide 202, permitting a phase-matching point that is farther from the end 210a of waveguide 202. Further, the shape of the segments 218 can be selected so that the derivatives of each of the effective refractive indices when the effective refractive indices are equal are within a range. For example, if the derivatives of the effective refractive indices are too high, the power transfer can be limited, e.g., the transfer is too “abrupt” or non-adiabatic. Conversely, if the derivatives of the effective refractive indices are too low, then the power of the optical signal can oscillate between the two layers. As disclosed herein, derivatives are parameters than can be numerically determined during design optimization.

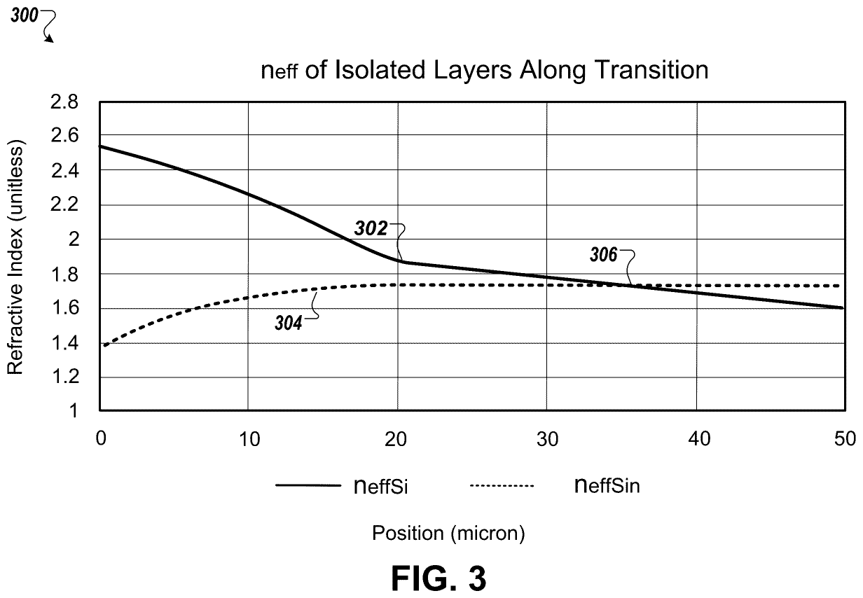

With reference to FIG. 3, plot 300 depicts the effective refractive indices of each of waveguides 202 and 204, in isolation, when composed of silicon (solid line) and silicon nitride (dashed line), respectively, as a function of distance along the propagation axis. For example, 0 μm corresponds to end 110b, and 50 μm corresponds to end 110a. The minimum and maximums of each of curves 302 and 304 are determined in part by the minimum and maximum widths of the waveguides 202 and 204. The shape of the segments 218 determine the shape of the curves 302 and 304 and thus where the two curves 302 and 304 intersect, and the value of the derivatives at the intersection point 306. In FIG. 3, the two curves 302 and 304 intersect at point 306, which is at about 35 μm. If each of the waveguides 202 and 204 simply had single-stage, linearly tapered sections, the point of intersection would be closer to 50 μm, e.g., 45 μm. Since the point 306 of intersection occurs further from the end, e.g., 50 μm, there is more length in the propagation direction for the optical signal to completely transfer upward.

At around 35 μm, the effective refractive indices of each of the waveguides 102 and 104 are equal. Accordingly, in a region around 35 μm, power is more efficiently transferred from waveguide 102 to waveguide 104. As a result, less optical power is left in waveguide 102 at end 110a. Further, for the remaining optical power in the end 110a, there is less optical absorption since the end 110a it is relatively wide.

The rate of change of the difference in effective refractive indices with respect to the position along the propagation axis, i.e., d(Δn_{eff})/dx, impacts how much power is transferred between the waveguide layers. For example, the derivative being above a threshold value, e.g., 0.7 μm⁻¹, can result in optical power transfer that is incomplete and can vary with the optical wavelength. On the other hand, being below a threshold value, e.g., 0.001 μm⁻¹, can result in waveguides that are impractically long, and for which the optical power can oscillate between the two waveguides. For example, very narrow waveguides having lengths that are much greater than the widths, e.g., 250 times more, are susceptible to breaking during fabrication. In some implementations, the rate of change of the effective refractive index with respect to the position along the propagation direction is between 0.01 μm⁻¹ and 0.07 μm⁻¹, e.g., 0.02 μm⁻¹, 0.03 μm⁻¹, 0.04 μm⁻¹, 0.05 μm⁻¹, and 0.06 μm⁻¹. In some implementations, the rate of change of the effective refractive index with respect to the position along the propagation direction is between 0.005 μm⁻¹ and 0.015 μm⁻¹ at the point of intersection, e.g., 0.006 μm⁻¹, 0.007 μm⁻¹, 0.008 μm⁻¹, 0.009 μm⁻¹, 0.01 μm⁻¹, 0.011 μm⁻¹, 0.012 μm⁻¹, 0.013 μm⁻¹, and 0.014 μm⁻¹. In some implementations, the length of the transition region, e.g., region of optical power transfer, is limited to a few tens of micron or less, e.g., 50 μm or less, 40 μm or less, 30 μm or less, 20 μm or less, or 10 μm or less, due to the available space within the chip floorplan.

With reference to FIGS. 4A and 4B, additionally or alternatively to the overlapping waveguides of FIG. 2A having tapered section with multiple segments whose widths vary according to multiple functions, efficient power transfer between different waveguide layers of a photonic device can be achieved using a “forked” structure. For example, waveguides composed of materials susceptible to optical damage, such as silicon, can have a forked structure.

A first device 400a includes waveguide 402a, waveguide 404a, and side waveguides 408a and 408b laterally offset from waveguide 402a, e.g., offset along the Y direction. As depicted by the key, waveguide 402a and the side waveguides 408a are composed of the same material, e.g., silicon. Similarly to waveguides 102 and 104, waveguides 402a and 404a overlap along the vertical direction, e.g., the Z direction, in an overlap region 406a. Further, side waveguides 408a and 408b overlap the waveguide 404a at the ends 410a and 410b of the respective side waveguides in overlap regions 406b and 406c. Waveguides 402a and 404a are disposed in a cladding layer 414 supported by a substrate 416.

With this configuration, optical power that is input near end 412 of waveguide 402a splits symmetrically along two different paths, e.g., going into each of the two side waveguides 408a and 408b (negligible power remains in waveguide 402a as the mode propagates toward the waveguide 404a). The vertical transition of optical power can begin at end 414 of waveguide 404a, since this portion vertically overlaps waveguide 402a, and end at the tips of the side waveguides 408a and 408b that overlap waveguide 404a.

As depicted in FIG. 4C, which is a cross-sectional view along line C-C′ from FIG. 4A, the side waveguides 408a and 408b are coplanar, e.g., at the same height along the Z direction. Further, the side waveguides 408a and 408b are the same height as the waveguide 402a. Advantageously, by splitting the optical power into multiple waveguides of the same material and height, more overall power can be input to the device 400 without risking overheating. For example, both of the side waveguides that are composed of a first material, e.g., waveguides 408a and 408b, individually carry half as much power or less compared to waveguide 102.

The ends 410a and 410b of the side waveguides 408a and 408b taper down to a width along the Y axis that is sufficiently small to ensure efficient power transfer from the lower waveguides, e.g., waveguides 402a and side waveguides 408a and 408b, to the upper waveguide, e.g., waveguide 404a. Further, ends 410c and 410d of the side waveguides 408a and 408b closer to the waveguide 402a are also tapered to encourage adiabatic power transfer from the waveguide 402a to the side waveguides 408a and 408b, e.g., power transfer along the Y direction, as the waveguide 402a narrows along the propagation direction.

Manufacturers of devices including overlapping waveguides can have specific rules controlling the design of the devices. For example, a particular foundry may have a minimum permissible distance between adjacent Si waveguides for devices with vertically overlapping Si and SiN waveguides. In such cases, the side waveguides 408a and 408b can be spaced further apart from the waveguide 402a in the Y direction, due to the overlap region 406a. However, other designs are possible to still achieve a design goal of increasing (e.g., maximizing) optical power transfer between different layers of a photonic device while avoiding ends of waveguides within the device being narrow enough to cause overheating.

For example, device 400b includes waveguides 402b and 404b and side waveguides 408a and 408b. Similarly to device 400a, the waveguides composed of a first material, e.g., waveguides 402b and side waveguides 408a and 408b, are all at the same height. Further, the side waveguides 408a and 408b composed of a first material vertically overlap waveguide 404b composed of a second material, e.g., in overlap regions 406d and 406e. Unlike device 400a, the central waveguides, e.g., waveguides 402b and 404b, of device 400b do not vertically overlap. Rather, there is a gap 416 between waveguides 402b and 404b when viewed along the Z direction.

Although not depicted, a first cross-sectional view of device 400b, e.g., defined by a surface having a surface normal along the X direction, would reveal a similar layout as the cross-sectional view in FIG. 4C. The side waveguides 408a and 408b are coplanar with each and so would appear at the same height along the Z direction.

Although not depicted in FIGS. 4A and 4B, the taper sections of each of waveguides 402a, 402b, 404a, 404b, 408a, and 408b can include multiple segments each having a unique function describe variation with, as described above.

With reference to FIG. 4D, other configurations for dividing up the optical power using multiple side waveguides as possible. For example, device 400d includes waveguide 404d, side waveguides 408c and 408d, a splitter 418, and an input port 420. The splitter 418, input port 420, and side waveguides 408c and 408d can all be made of the same material, e.g., silicon. The splitter 418 splits an optical signal into approximately equally power signals to propagate along each of the side waveguides 408c and 408d.

Side waveguides 408c and 408d vertically overlap with waveguide 404d, e.g., along the vertical, Z direction, so that the optical signal can transition from the side waveguides 408c and 408d into the waveguide 404d, e.g., a silicon nitride waveguide.

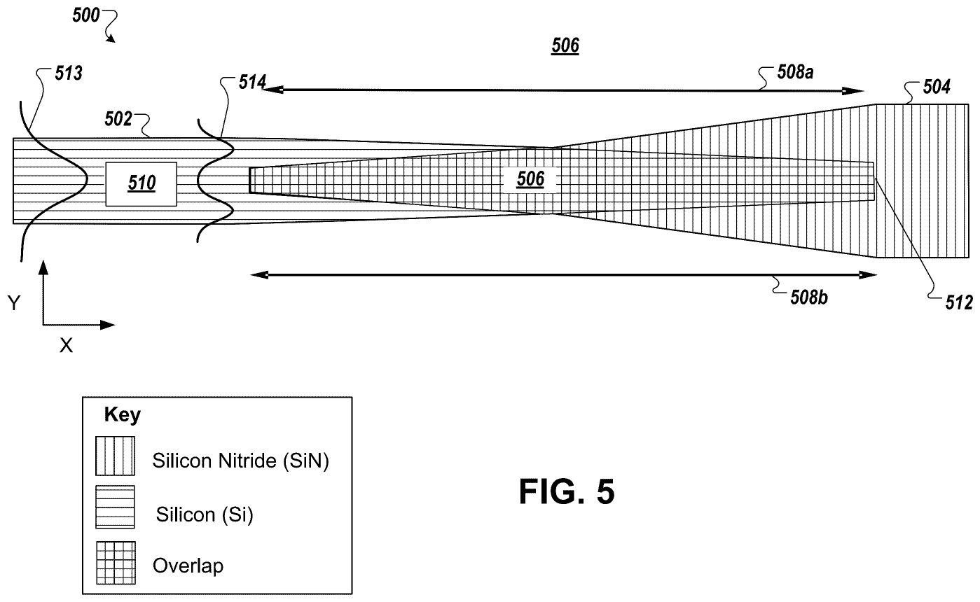

The design of overlapping waveguides in a multilayered photonic device can take advantage of different modes experiencing different refractive indices in a material. For example, with reference to FIG. 5, a device 500 includes waveguides 502 and 504, which overlap, along the Z axis, in an overlap region 506. Each of waveguides 502 and 504 include a tapered section, e.g., tapered sections 508a and 508b, respectively.

Waveguide 502 includes a mode converter 510, which is configured to convert a lower mode 513 into a higher mode 514 within the waveguide 502. Generally, higher-order transverse electric (TE) modes experience lower effective indices of refraction than lower-order TE modes do. As a result, when waveguide 502 has a higher refractive index than that of waveguide 504, increasing the order of a TE mode in waveguide 502 can reduce the difference in the effective refractive indices between waveguides 502 and 504. Accordingly, converting a TE₀ mode to a TE₂ mode can allow for achieving the phase matching condition while maintaining a sufficiently wide end 512, thereby avoiding issues with overly narrow ends, such as optical absorption and the risk of breaking.

The converted optical signal 514 in the waveguide 502 is in the TE₂ mode as the optical signal approaches the overlap region 506. As the optical signal transfers from the waveguide 502 to the waveguide 504, the optical signal returns to the fundamental TE₀ mode. Thus, the phase matching condition is between the TE₂ mode in the waveguide 502 (composed of a material with a higher index) and the TE₀ mode in waveguide 504 (composed of a material with a lower index). Therefore, equal effective indices of refraction can be obtained without the width of the waveguide 502 being small enough to cause overheating.

In this example, the mode converter converts the fundamental mode TE₀ to the second order mode TE₂, but other implementations, e.g., using higher-order, even-ordered modes, are possible. Although the previous description applied to transverse electric mode, a mode converter could also change the order of transverse magnetic (TM) modes, e.g., generally changing from a fundamental to higher-order mode.

Although not depicted in FIG. 5, each of waveguides 502 and 504 can include tapered section having multiple segments each having a unique function controlling the variation in width, as described above. Further, using tapered sections having multiple segments each having unique functions controlling the variation in width can also be combined with the forked configuration as described in relation to FIGS. 4A, 4B, and 4C, the mode converter of FIG. 5, for both.

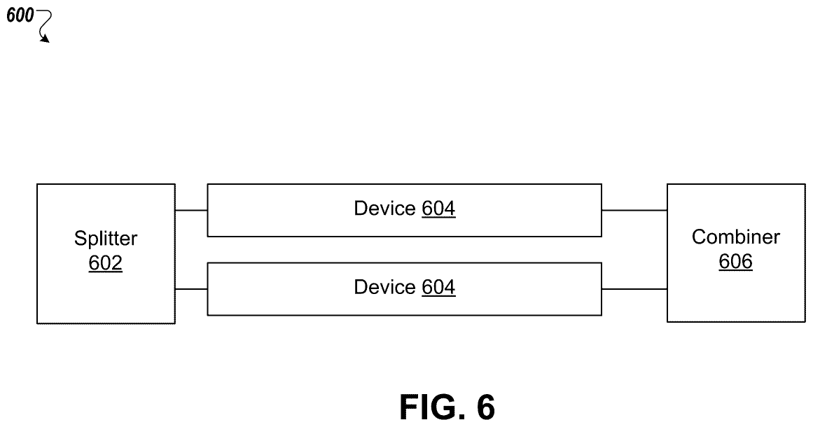

Generally, multiple of the disclosed devices can be utilized in a single system. With reference to FIG. 6, system 600 includes a splitter 602, devices 604, and combiner 606. The splitter 602 divides an optical signal into as many component signals as there are devices 604. The combiner 606 receives the component signals from the devices 604 and combines the component signals into a single, optical signal.

The devices 604 are identical to each other, e.g., have the same material composition and effective refractive index. For example, each of devices 604 can be any of devices 100, 200, 400a, 400b, 400d, or 500. In this example, there are two devices 604, but other implementations can include more devices. By dividing the optical signal into multiple component signals, each device 604 (and therefore subcomponents of the device 604, such as waveguides) carry less optical power, thereby reducing the risk of optical damage.

In general, the devices described here can be designed for an operative wavelength(s) in a variety of bands in the EM spectrum, e.g., C-band, O-band, visible light, and infrared light.

In addition to the embodiments of the attached claims and the embodiments described above, the following numbered embodiments are also innovative.

In general, innovative aspects of the subject matter described in this specification can be embodied in photonic integrated circuit including: a substrate extending in a plane; a cladding layer supported by the substrate; a first waveguide extending in the plane, the first waveguide being composed of a first material disposed within the cladding layer, the first waveguide including a tapered section that terminates at an end of the first waveguide, the tapered section of the first waveguide including one or more segments each having a width that varies according to a different, respective function; and a second waveguide extending in the plane, the second waveguide being composed of a second material disposed within the cladding layer, the second waveguide including a tapered section that terminates at an end of the second waveguide, the tapered section of the second waveguide including one or more segments each having a width that varies according to a different, respective function. The first material is different from the second material, the first waveguide is offset from the second waveguide in a vertical direction perpendicular to the plane, and the tapered section of the first waveguide overlaps with the tapered section of the second waveguide.

Another general aspect can be embodied in a photonic integrated circuit including: a substrate extending in a plane; a cladding layer supported by the substrate; a first waveguide extending in the plane, the first waveguide being composed of a first material disposed within the cladding layer, the first waveguide including a tapered section that terminates at an end of the first waveguide; a second waveguide extending in the plane, the second waveguide being composed of a second material disposed within the cladding layer, the second waveguide including a tapered section that terminates at an end of the second waveguide; and side waveguides laterally offset from the first waveguide. The first material is different from the second material, and the first waveguide is offset from the second waveguide in a vertical direction perpendicular to the plane.

Another general aspect can be embodied in a photonic integrated circuit including: a substrate extending in a plane; a cladding layer supported by the substrate; a first waveguide extending in the plane and composed of a first material disposed within the cladding layer, the first waveguide including a first length configured to support a first guided mode, a mode converter configured to convert the first guided mode into a second, different mode, and a tapered section; and a second waveguide extending in the plane, the second waveguide being composed of a second material disposed within the cladding layer, the second waveguide including a tapered section that terminates at an end of the second waveguide. The first material is different from the second material, the first waveguide is offset from the second waveguide in a vertical direction perpendicular to the plane, and the tapered section of the first waveguide vertically overlaps with the tapered section of the second waveguide.

These and other implementations can each optionally include one or more of the following features.

In some implementations, the respective functions include at least one of a linear function, an exponential function, and a parabolic function.

In some implementations, the respective functions include a numerically optimized function.

In some implementations, an upper limit of an absolute value of a rate of change of effective refractive indices is low enough such that power transfer between the first and second waveguides is adiabatic, and a lower limit of the absolute value of the rate of change of effective refractive indices is high enough such that derivatives of the effective refractive index with respect to position of each of the first and second waveguides intersect between the respective ends of the first and second waveguides.

In some implementations, the one or more segments of the first waveguide include first multiple segments. The one or more segments of the second waveguide include second multiple segments.

In some implementations, the first multiple segments include three or more segments. The second multiple segments include three or more segments.

In some implementations, the tapered section of the first waveguide vertically overlaps with the tapered section of the second waveguide.

In some implementations, the side waveguides are coplanar with the first waveguide.

In some implementations, the first waveguide and the second waveguide are offset in the vertical direction.

In some implementations, the tapered section of at least one of the first and second waveguides includes multiple segments each having a width that varies according to a different, respective function.

In some implementations, the first guided mode is a fundamental transverse mode (TE₀ or TM₀), and the second guided mode is a higher-order transverse mode (TE₂ or TM₂).

In some implementations, the tapered section of at least one of the first and second waveguides includes multiple segments each having a width that varies according to a different, respective function.

In some implementations, for an operative wavelength, an effective refractive index of the first waveguide is equal to an effective refractive index of the second waveguide in a region where the first and second waveguides overlap along the vertical direction.

In some implementations, for an operative wavelength, a refractive index of the first material is greater than a refractive index of the second material.

In some implementations, the second direction is a propagation axis for light waveguided within the photonic integrated circuit.

In some implementations, the cladding layer includes silicon dioxide, the first waveguide includes silicon, and the second waveguide includes silicon nitride, and the substrate includes silicon.

In some implementations, a length of the semiconductor chip along a lateral direction is tens of microns long.

In some implementations, an optical system includes: an optical splitter configured to receive and split an optical signal into a plurality of split optical signals; a plurality of the photonic integrated circuits of any single preceding implementation, the plurality of the photonic integrated circuits configured to receive the plurality of split optical signals, where the plurality of the photonic integrated circuits are substantially identical to each other, each split optical signal of the plurality of split optical signals propagating in a respective photonic integrated circuit of the plurality of the photonic integrated circuits; and an optical combiner configured to receive the plurality of split optical signals and combine the plurality of split optical signals into a single, combined optical signal.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Particular embodiments of the subject matter have been described. Other embodiments are within the scope of the following claims.

What is claimed is:

1. A photonic integrated circuit comprising:
a substrate extending in a plane;
a cladding layer supported by the substrate;
a first waveguide extending in the plane, the first waveguide being composed of a first material disposed within the cladding layer, the first waveguide comprising a tapered section that terminates at an end of the first waveguide, the tapered section of the first waveguide comprising one or more segments each having a width that varies according to a different, respective function; and
a second waveguide extending in the plane, the second waveguide being composed of a second material disposed within the cladding layer, the second waveguide comprising a tapered section that terminates at an end of the second waveguide, the tapered section of the second waveguide comprising one or more segments each having a width that varies according to a different, respective function,
wherein the first material is different from the second material, the first waveguide is offset from the second waveguide in a vertical direction perpendicular to the plane, and the tapered section of the first waveguide overlaps with the tapered section of the second waveguide.

2. The photonic integrated circuit of claim 1, wherein the respective functions comprise at least one of a linear function, an exponential function, and a parabolic function.

3. The photonic integrated circuit of claim 1, wherein the respective functions comprise a numerically optimized function.

4. The photonic integrated circuit of claim 1, wherein an upper limit of an absolute value of a rate of change of effective refractive indices is low enough such that power transfer between the first and second waveguides is adiabatic, and a lower limit of the absolute value of the rate of change of effective refractive indices is high enough such that derivatives of the effective refractive index with respect to position of each of the first and second waveguides intersect between the respective ends of the first and second waveguides.

5. The photonic integrated circuit of claim 1, wherein the one or more segments of the first waveguide comprise first multiple segments, and wherein the one or more segments of the second waveguide comprise second multiple segments.

6. The photonic integrated circuit of claim 4, wherein the one or more segments of the first waveguide comprise three or more segments, and wherein the one or more segments of the second waveguide comprise three or more segments.

7. A photonic integrated circuit comprising:
a substrate extending in a plane;
a cladding layer supported by the substrate;
a first waveguide extending in the plane, the first waveguide being composed of a first material disposed within the cladding layer, the first waveguide comprising a tapered section that terminates at an end of the first waveguide;
a second waveguide extending in the plane, the second waveguide being composed of a second material disposed within the cladding layer, the second waveguide comprising a tapered section that terminates at an end of the second waveguide; and
side waveguides laterally offset from the first waveguide,
wherein the first material is different from the second material, and the first waveguide is offset from the second waveguide in a vertical direction perpendicular to the plane.

8. The photonic integrated circuit of claim 7, wherein the tapered section of the first waveguide vertically overlaps with the tapered section of the second waveguide.

9. The photonic integrated circuit of claim 7, wherein the side waveguides are coplanar with the first waveguide.

10. The photonic integrated circuit of claim 7, wherein the first waveguide and the second waveguide are offset in the vertical direction.

11. The photonic integrated circuit of claim 7, wherein the tapered section of at least one of the first and second waveguides comprises multiple segments each having a width that varies according to a different, respective function.

12. A photonic integrated circuit comprising:
a substrate extending in a plane;
a cladding layer supported by the substrate;
a first waveguide extending in the plane and composed of a first material disposed within the cladding layer, the first waveguide comprising a first length configured to support a first guided mode, a mode converter configured to convert the first guided mode into a second, different guided mode, and a tapered section; and
a second waveguide extending in the plane, the second waveguide being composed of a second material disposed within the cladding layer, the second waveguide comprising a tapered section that terminates at an end of the second waveguide,
wherein the first material is different from the second material, the first waveguide is offset from the second waveguide in a vertical direction perpendicular to the plane, and the tapered section of the first waveguide vertically overlaps with the tapered section of the second waveguide.

13. The photonic integrated circuit of claim 12, wherein the first guided mode is a fundamental transverse mode (TE₀ or TM₀), and the second guided mode is a higher-order transverse mode (TE₂ or TM₂).

14. The photonic integrated circuit of claim 12, wherein the tapered section of at least one of the first and second waveguides comprises multiple segments each having a width that varies according to a different, respective function.

15. The photonic integrated circuit of claim 12, wherein, for an operative wavelength, an effective refractive index of the first waveguide is equal to an effective refractive index of the second waveguide in a region where the first and second waveguides overlap along the vertical direction.

16. The photonic integrated circuit of claim 12, wherein, for an operative wavelength, a refractive index of the first material is greater than a refractive index of the second material.

17. The photonic integrated circuit of claim 12, wherein the second direction is a propagation axis for light waveguided within the photonic integrated circuit.

18. The photonic integrated circuit of claim 12, wherein the cladding layer comprises silicon dioxide, the first waveguide comprises silicon, and the second waveguide comprises silicon nitride, and the substrate comprises silicon.

19. The photonic integrated circuit of claim 12, wherein a length of the substrate along a lateral direction is tens of microns long.

20. An optical system including:
an optical splitter configured to receive and split an optical signal into a plurality of split optical signals;
a plurality of photonic integrated circuits, the plurality of the photonic integrated circuits configured to receive the plurality of split optical signals, wherein the plurality of the photonic integrated circuits are substantially identical to each other, each split optical signal of the plurality of split optical signals propagating in a respective photonic integrated circuit of the plurality of the photonic integrated circuits; and
an optical combiner configured to receive the plurality of split optical signals and combine the plurality of split optical signals into a single, combined optical signal.
